(19) United States
(12) Patent Application Publication
(10) Pub. No.: US 2024/0264884 A1
(43) Pub. Date: Aug. 8, 2024

(54) CONFIGURATION DRIVEN MONITORING

(71) Applicant: Dell Products L.P., Round Rock, TX (US)

(72) Inventors: Amitava Roy, Lexington, MA (US); Peter Smoot, San Jose, CA (US); Jianning Zhuang, Irvine, CA (US)

(73) Assignee: Dell Products L.P., Round Rock, TX (US)

(21) Appl. No.: 18/104,818

(22) Filed: Feb. 2, 2023

(51) Int. Cl. G06F 9/54

(52) U.S. Cl. CPC G06F 9/542; G06F 9/547

(57) ABSTRACT

Methods, system, and non-transitory processor-readable storage medium for an exporter creation system are provided herein. An example method includes generating by an exporter creation system, a metric exporter for metrics associated with the microservice. The metric exporter is generated according to event monitoring system specifications using the configuration file. The exporter creation system registers the metric exporter with a library associated with an event monitoring system. The metric exporter provides the metrics to the event monitoring system upon receiving a request from the event monitoring system.

### FIELD

The field relates generally to monitoring metrics, and more particularly to monitoring metrics of microservices in information processing systems.

### BACKGROUND

Event monitoring systems monitor microservices and provide client libraries that are used to expose the internal metrics of a microservice. Developers familiarize themselves with the client library and use the client library to build a metrics exporter for the microservice so that the event monitoring system can obtain the metrics from the microservice.

### SUMMARY

Illustrative embodiments provide techniques for implementing an exporter creation system in a storage system. For example, illustrative embodiments provide an exporter creation system that reads a configuration file associated with a microservice. The exporter creation system generates a metric exporter for metrics associated with the microservice. The metric exporter is generated according to event monitoring system specifications using the configuration file. The exporter creation system registers the metric exporter with a library associated with an event monitoring system. The metric exporter provides the metrics to the event monitoring system upon receiving a request from the event monitoring system. Other types of processing devices can be used in other embodiments. These and other illustrative embodiments include, without limitation, apparatus, systems, methods and processor-readable storage media.

### BRIEF DESCRIPTION OF THE DRAWINGS

FIG. 1 shows an information processing system including an exporter creation system in an illustrative embodiment.

FIG. 2 shows a flow diagram of a process for an exporter creation system in an illustrative embodiment.

FIGS. 3 and 4 show examples of processing platforms that may be utilized to implement at least a portion of an exporter creation system embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

Described below is a technique for use in implementing an exporter creation system, which technique may be used to provide, among other things standardizing implementation of exposing metrics of a microservice to an event monitoring system. An exporter creation system reads a configuration file associated with a microservice. The exporter creation system generates a metric exporter for metrics associated with the microservice. The metric exporter is generated according to event monitoring system specifications using the configuration file. The exporter creation system registers the metric exporter with a library associated with an event monitoring system. The metric exporter provides the metrics to the event monitoring system upon receiving a request from the event monitoring system. Other types of processing devices can be used in other embodiments

An example of an event monitoring system is Prometheus. Prometheus supplies client libraries in popular languages, which can be used to expose internal metrics of a microservice via an http endpoint. Typically, a developer needs to be familiar with the client library, and then use the library to build the metric exporter. The developer then needs to test the custom-built metric exporter in the microservice prior to delivering the microservice. When multiplied by the number of microservices running, and the number of developers that an organization may have, an enormous amount of time is spent by the organization writing custom exporters to expose the metrics of a microservice to an event monitoring system, such as Prometheus.

Conventional technologies require that developers understand the data collection approach of each event monitoring system used by the organization. Conventional technologies require that an exporter is written from scratch for each microservice. Conventional technologies that require individually custom written exporters are error prone and not scalable. Conventional technologies do not ensure that microservices are monitored uniformly throughout an organization to help developers triage and troubleshoot issues. Conventional technologies do not ensure that metrics are generated per the specifications of any of the event monitoring systems that are used. Conventional technologies do not provide a standard implementation for exposing metrics of a microservice and exporting the metrics to an event monitoring system, thus making it difficult to provide support when issues arise. Conventional technologies do not provide a system that is scalable and not error prone. Conventional technologies do not streamline error handling.

By contrast, in at least some implementations in accordance with the current technique as described herein, an exporter creation system standardizes implementation of exposing metrics of a microservice to an event monitoring system. An exporter creation system reads a configuration file associated with a microservice. The exporter creation system generates a metric exporter for metrics associated with the microservice. The metric exporter is generated according to event monitoring system specifications using the configuration file. The exporter creation system registers the metric exporter with a library associated with an event monitoring system. The metric exporter provides the metrics to the event monitoring system upon receiving a request from the event monitoring system.

Thus, a goal of the current technique is to provide a method and a system for providing an exporter creation system that standardizes implementation of exposing metrics of a microservice to an event monitoring system. Another goal is to provide a configuration-based approach to export metrics from microservices to an event monitoring system. Another goal is to ensure that uniform monitoring occurs across all microservices to help developers triage and troubleshoot issues. Another goal is to ensure that the metrics generated are per the specifications of the event monitoring system. Another goal is to create a system where the developer does not have to write a customer exporter, or allocate an http server. Another goal is to create a system where the developer only needs to supply the configuration file and the business logic that generates the metrics values, and the exporter creation system creates the exporter that supplies the metrics values to the event monitoring system. Another goal is to provide a system that is scalable and not error prone. Yet another goal is to streamline error handling.

In at least some implementations in accordance with the current technique described herein, the use of an exporter creation system can provide one or more of the following advantages: providing a configuration based approach to export metrics from microservices to an event monitoring system, ensuring that uniform monitoring occurs across all microservices to help developers triage and troubleshoot issues, ensuring that the metrics generated are per the specifications of the event monitoring system, creating a system where the developer does not have to write a customer exporter, or allocate an http server, creating a system where the developer only needs to supply the configuration file and the business logic that generates the metrics values, and the exporter creation system creates the exporter that supplies the metrics values to the event monitoring system, allowing the event monitoring system to scrape the metrics generated by the microservice, providing a system that is scalable and not error prone, and streamlining error handling.

In contrast to conventional technologies, in at least some implementations in accordance with the current technique as described herein, an exporter creation system reads a configuration file associated with a microservice. The exporter creation system generates a metric exporter for metrics associated with the microservice. The metric exporter is generated according to event monitoring system specifications using the configuration file. The exporter creation system registers the metric exporter with a library associated with an event monitoring system. The metric exporter provides the metrics to the event monitoring system upon receiving a request from the event monitoring system.

In an example embodiment of the current technique, the exporter creation system initiates a server, where the server receives the request from the event monitoring system to provide the metrics to the event monitoring system.

In an example embodiment of the current technique, the exporter creation system obtains a value of a port associated with the server.

In an example embodiment of the current technique, the exporter creation system obtains the value of the port from at least one of the configuration file, a second configuration file and source code associated with the microservice.

In an example embodiment of the current technique, the exporter creation system generates the metric exporter during a runtime initialization of the microservice.

In an example embodiment of the current technique, the exporter creation system identifies an array in the configuration file, where the array comprises at least one metric element, and generates a collector object according to the event monitoring system specifications for each metric element in the array.

In an example embodiment of the current technique, at least one metric element comprises at least one event monitoring system construct used by the event monitoring system.

In an example embodiment of the current technique, at least one metric element comprises a collector section identifying a location of metric generating logic in source code associated with the microservice, where the metric generating logic generates a portion of the metrics associated with the microservice.

In an example embodiment of the current technique, the exporter creation system parses the configuration file to locate the collector section, where the collector section comprises method implementations of the metric generating logic in the source code.

In an example embodiment of the current technique, the exporter creation system provides an abstract method from which the method implementations of the metric generating logic are generated as concrete implementations of the abstract method.

In an example embodiment of the current technique, the exporter creation system constructs an instance of each of the concrete implementations and creates a respective collector object from each instance.

In an example embodiment of the current technique, each respective collector object comprises a respective reference to the instance of each of the concrete implementations and a respective reference to each of the event monitoring system constructs used by the event monitoring system.

In an example embodiment of the current technique, the exporter creation system is written in an interpreted language, and the collector section comprises at least one module name of a module that contains the method implementations of the metric generating logic in the source code.

In an example embodiment of the current technique, the collector object has a reference to at least one event monitoring system construct used by the event monitoring system.

In an example embodiment of the current technique, the configuration file is written in a data serialization language.

In an example embodiment of the current technique, the exporter creation system registers a collector object associated with the configuration file with the library associated with the event monitoring system.

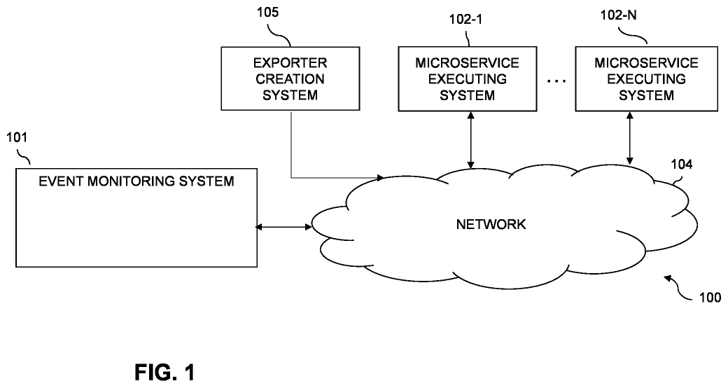

FIG. 1 shows a computer network (also referred to herein as an information processing system) 100 configured in accordance with an illustrative embodiment. The computer network 100 comprises an event monitoring system 101, exporter creation system 105, and microservice executing systems 102-N. The event monitoring system 101 scrapes the metrics generated by the microservice executing systems 102-N. The event monitoring system 101, exporter creation system 105, and microservice executing systems 102-N are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is an exporter creation system 105 that may reside on a storage system. Such storage systems can comprise any of a variety of different types of storage including network-attached storage (NAS), storage area networks (SANs), direct-attached storage (DAS) and distributed DAS, as well as combinations of these and other storage types, including software-defined storage.

Each of the microservice executing systems 102-N may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The microservice executing systems 102-N in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Also associated with the exporter creation system 105 are one or more input-output devices, which illustratively comprise keyboards, displays or other types of input-output devices in any combination. Such input-output devices can be used, for example, to support one or more user interfaces to the exporter creation system 105, as well as to support communication between the exporter creation system 105 and other related systems and devices not explicitly shown. For example, a dashboard may be provided for a user to view a progression of the execution of the exporter creation system 105. One or more input-output devices may also be associated with any of the microservice executing systems 102-N.

Additionally, the exporter creation system 105 in the FIG. 1 embodiment is assumed to be implemented using at least one processing device. Each such processing device generally comprises at least one processor and an associated memory, and implements one or more functional modules for controlling certain features of the exporter creation system 105.

More particularly, the exporter creation system 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the exporter creation system 105 to communicate over the network 104 with the event monitoring system 101, and microservice executing systems 102-N and illustratively comprises one or more conventional transceivers.

An exporter creation system 105 may be implemented at least in part in the form of software that is stored in memory and executed by a processor, and may reside in any processing device. The exporter creation system 105 may be a standalone plugin that may be included within a processing device.

It is to be understood that the particular set of elements shown in FIG. 1 for exporter creation system 105 involving the event monitoring system 101, and microservice executing systems 102-N of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the exporter creation system 105 can be on and/or part of the same processing platform.

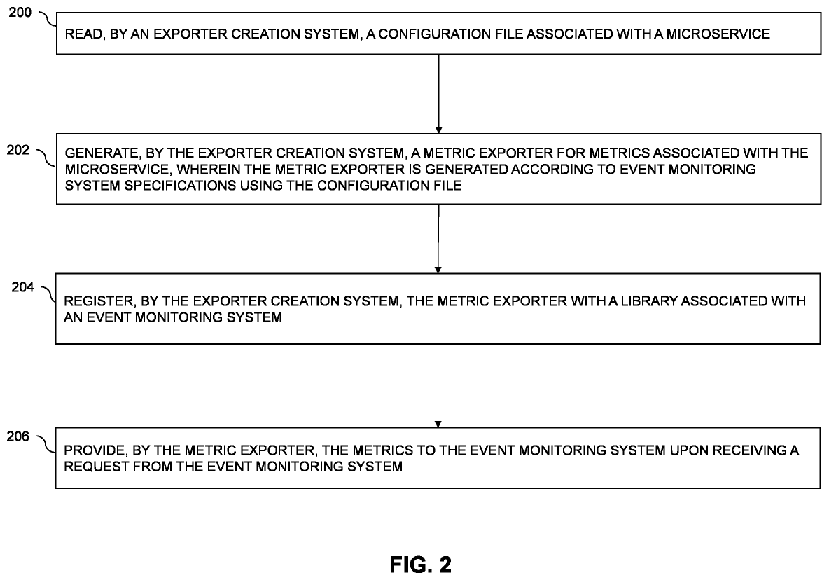

An exemplary process of exporter creation system 105 in computer network 100 will be described in more detail with reference to, for example, the flow diagram of FIG. 2.

FIG. 2 is a flow diagram of a process for execution of the exporter creation system 105 in an illustrative embodiment. It is to be understood that this particular process is only an example, and additional or alternative processes can be carried out in other embodiments.

At 200, the exporter creation system 105 reads a configuration file associated with a microservice. In an example embodiment, the configuration file is written in a data serialization language, for example, such as YAML which is a human-readable data-serialization language. An example configuration file is illustrated below.

```
metrics:
- name: test_metric2
  description: example metric2 in the ms
  labels: [‘l1’, ‘l2’]
  type: GAUGE
  collector:
    module: metricgenerator2
    class: MetricGenerator2
- name: test_metric3
  description: example metric3 in ms
  labels: [‘l1’]
  type: COUNTER
  collector:
    module: metricgenerator3
    class: MetricGenerator3
```

In an example embodiment, “metrics” in the above configuration file is an array.

At 202, the exporter creation system 105 generates a metric exporter for metrics associated with the microservice. In an example embodiment, the exporter creation system 105 generates the metric exporter during a runtime initialization of the microservice. In an example embodiment, the metric exporter is generated according to event monitoring system specifications using the configuration file. In an example embodiment, the exporter creation system 105 identifies an array in the configuration file, where the array comprises at least one metric element. In an example embodiment, at least one metric element comprises at least one event monitoring system construct used by the event monitoring system. For example, the event monitoring system 101 may be the Prometheus event monitoring system. Prometheus requires each metric to have Prometheus constructs, such as “name”, “description”, and “type”. Another Prometheus construct, “labels” is optional. In the above configuration file example, the “labels” construct is present, but, since it is optional, in a different configuration file, it may be an empty array [] or simply absent.

In an example embodiment, the exporter creation system 105 generates a collector object according to the event monitoring system specifications for each metric element in the array. As illustrated above in the example configuration file, each metric element comprises a collector section that identifies a location of metric generating logic in source code associated with the microservice. The metric generating logic generates a portion of the metrics associated with the microservice. In an example embodiment, the exporter creation system 105 parses the configuration file to locate the collector section. The collector section comprises method implementations of the metric generating logic in the source code. In the above example configuration file, the method implementation of the metric generating logic in the source code is “MetricGenerator3”.

In an example embodiment, the exporter creation system 105 provides an abstract method from which the method implementations of the metric generating logic are generated as concrete implementations of the abstract method. For example, the exporter creation system 105 may provide an abstract base class, “ABCMetricGenerator” that contains an abstract method, “generate_metric( )”. A developer provides a concrete implementation of the abstract method in a class that is inherited from “ABCMetricGenerator”. In an example embodiment, the concrete implementation of the “generate_metric( )” method contains the metric generating logic that generates the metrics during execution of the microservice.

In an example embodiment, the exporter creation system 105 is written in an interpreted language, for example, Python. In this example embodiment, the configuration file comprises a collector section that contains at least one module name of a module that contains the method implementations of the metric generating logic in the source code. For example, the configuration file illustrated above contains a “collector” section that contains the concrete implementation of the “generate_metric( )” method, and the python module that contains the “generate_metric( )” method. These two elements are defined under the “collector” section of each metric with keys “class” and “module” respectively. In another example embodiment, if the source code is written in a non-interpreted language, the concrete implementation is available in binary.

In an example embodiment, the exporter creation system 105 constructs an instance of each of the concrete implementations, and creates a respective collector object from each instance. In an example embodiment, during an initialization of the microservice, the microservice invokes an initialization routine in the exporter creation system 105, using the configuration file. In an example embodiment, the exporter creation system 105 locates and loads, via reflection, all the concrete implementation classes of “ABCMetricGenerator”. The exporter creation system 105 obtains the names and implementations of the concrete classes (which contain the metric generation business logic) by loading the configuration file, and parsing the array under the “collector” key in the configuration file. In an example embodiment, once the concrete classes are located and loaded into memory, the exporter creation system 105 constructs an instance of each loaded class and creates a collector object, using the newly created instance. In an example embodiment, the exporter creation system 105 creates a separate collector object for each class instance.

In an example embodiment, each collector object is constructed according to the specifications of the event monitoring system 101. In an example embodiment, each respective collector object comprises a respective reference to the instance of each of the concrete implementations and a respective reference to each of the event monitoring system constructs used by the event monitoring system. In an example embodiment, the collector object has a reference to at least one event monitoring system construct used by the event monitoring system. For example, if the event monitoring system 101 is the Prometheus event monitoring system, the collector object has references to the “name”, “description”, “type”, and (if included) “labels” for each concrete instance as specified in the configuration file.

At 204, the exporter creation system 105 registers the metric exporter with a library associated with an event monitoring system. In an example embodiment, the exporter creation system 105 registers the collector object associated with the configuration file with the library associated with the event monitoring system. For example, if the event monitoring system 101 is the Prometheus event monitoring system, the exporter creation system 105 registers the collector object with the Prometheus exporter client library. In an example embodiment, a collector object is built and registered for each element of the metrics array in the configuration file.

At 206, the exporter creation system 105 provides the metrics to the event monitoring system 101 upon receiving a request from the event monitoring system 101. In an example embodiment, the exporter creation system 105 initiates a server in the microservice. In an example embodiment, the microservice is executing on the microservice executing system 102-N. In an example embodiment, a http server needs to be started in the microservice. This is part of a startup sequence for the microservice and has to be started when the microservice is running. The server receives the request from the event monitoring system 101 to provide the metrics to the event monitoring system 101. The exporter creation system 105 obtains the value of a port associated with the server. In an example embodiment, the exporter creation system 105 may obtain the value of the port from the configuration file, a second file, or source code associated with the microservice.

In an example embodiment, if the event monitoring system 101 is Prometheus, once the microservice is in operation, Prometheus scrapes the microservice generated metric values, at regular intervals by sending a RestAPI request to the http_server to collect metrics. The metric values are generated by the microservice executing systems 102-N. The Prometheus library in each microservice has knowledge of each of the registered collector objects, and each of the registered collector objects are called to provide metrics values. As noted above, each collector object has reference to a concrete instance of the “ABCMetricGenerator” class, along with the associated specifications as detailed in the configuration file. The collector object calls the “generate_metric( )” function of the derived class instance (and this executes the business logic in the microservice logic). The values generated by the business logic are returned to Prometheus for each RestAPI request.

In an example embodiment, the exporter creation system 105 may be enhanced to expose default additional metrics, for example, metrics that are in addition to those that are collected by default by the event monitoring system 101. For example, an organization may decide to collect additional metrics. In an example embodiment, the event monitoring system 101 may collect default metrics without a configuration file. For example, these default metrics may be hard coded in the exporter creation system 105, or in a separate configuration file (i.e., such as the second configuration file referenced above that, for example, may specify the port of the http server).

In an example embodiment, the exporter creation system 105 allows verification of generated metrics on the client side, for example, before the generated metrics are sent to the event monitoring system 101. This verification process identifies generated metrics that are not per the specification of the event monitoring system 101. For example, if the business logic generates a string as the value of the metric, and the event monitoring system 101 only accepts measurable values (and a string is a non-measurable value in this example scenario), the exporter creation system 105 identifies this error before the event monitoring system 101 scrapes the microservice for metrics. In an example embodiment, a local verification process is performed before sending the metrics to the event monitoring system 101. This local verification process runs locally even if the event monitoring system 101 has not been installed. The local verification process allows “unit-tests” to be developed. Even if “unit-tests” are not developed, error messages will appear in the microservice log during operation. Without the exporter creation system 105 creating the custom exporter, errors are sent to the event monitoring system 101, and the event monitoring system 101, upon detecting the error, drops the metric, and generates an error log. In this example scenario, developers would now need to know how to identify errors in each of the event monitoring systems 101 used.

Accordingly, the particular processing operations and other functionality described in conjunction with the flow diagram of FIG. 2 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to standardize implementation of exposing metrics of a microservice to an event monitoring system. These and other embodiments can effectively improve microservice metrics collection using event monitoring systems relative to conventional approaches. For example, embodiments disclosed herein provide a configuration based approach to export metrics from microservices to an event monitoring system. Embodiments disclosed herein ensure that uniform monitoring occurs across all microservices to help developers triage and troubleshoot issues. Embodiments disclosed herein ensure that the metrics generated are per the specifications of the event monitoring system. Embodiments disclosed herein create a system where the developer does not have to write a customer exporter, or allocate an http server. Embodiments disclosed herein create a system where the developer only needs to supply the configuration file and the business logic that generates the metrics values, and the exporter creation system creates the exporter that supplies the metrics values to the event monitoring system. Embodiments disclosed herein provide a system that is scalable and not error prone. Embodiments disclosed herein streamline error handling.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the information processing system 100. For example, containers can be used to implement respective processing devices providing compute and/or storage services of a cloud-based system. Again, containers may be used in combination with other virtualization infrastructure such as virtual machines implemented using a hypervisor.

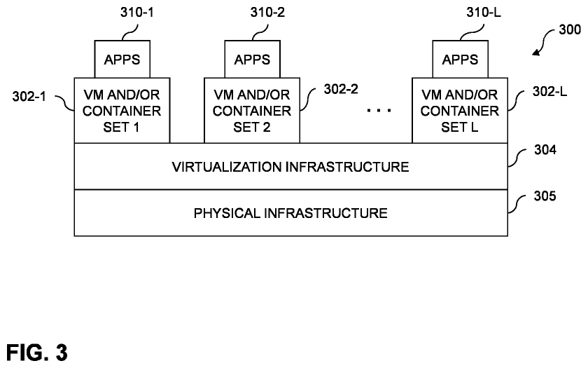

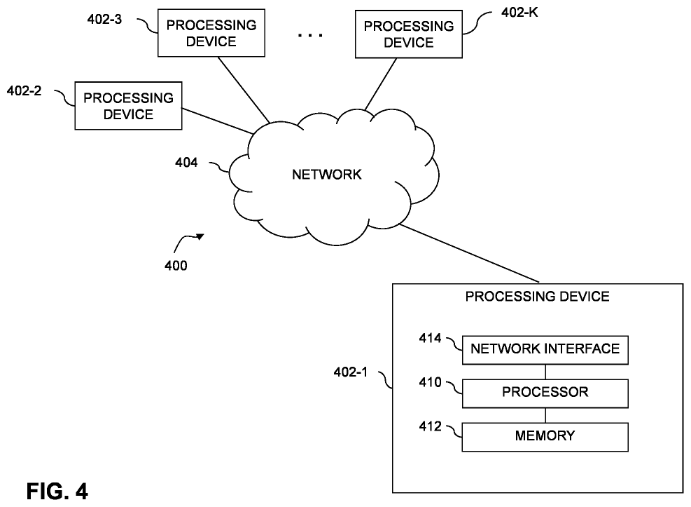

Illustrative embodiments of processing platforms will now be described in greater detail with reference to FIGS. 3 and 4. Although described in the context of the information processing system 100, these platforms may also be used to implement at least portions of other information processing systems in other embodiments.

FIG. 3 shows an example processing platform comprising cloud infrastructure 300. The cloud infrastructure 300 comprises a combination of physical and virtual processing resources that are utilized to implement at least a portion of the information processing system 100. The cloud infrastructure 300 comprises multiple virtual machines (VMs) and/or container sets 302-1, 302-2, . . . 302-L implemented using virtualization infrastructure 304. The virtualization infrastructure 304 runs on physical infrastructure 305, and illustratively comprises one or more hypervisors and/or operating system level virtualization infrastructure. The operating system level virtualization infrastructure illustratively comprises kernel control groups of a Linux operating system or other type of operating system.

The cloud infrastructure 300 further comprises sets of applications 310-1, 310-2, . . . 310-L running on respective ones of the VMs/container sets 302-1, 302-2, . . . 302-L under the control of the virtualization infrastructure 304. The VMs/container sets 302 comprise respective VMs, respective sets of one or more containers, or respective sets of one or more containers running in VMs. In some implementations of the FIG. 3 embodiment, the VMs/container sets 302 comprise respective VMs implemented using virtualization infrastructure 304 that comprises at least one hypervisor.

A hypervisor platform may be used to implement a hypervisor within the virtualization infrastructure 304, where the hypervisor platform has an associated virtual infrastructure management system. The underlying physical machines comprise one or more distributed processing platforms that include one or more storage systems.

In other implementations of the FIG. 3 embodiment, the VMs/container sets 302 comprise respective containers implemented using virtualization infrastructure 304 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of the information processing system 100 may each run on a computer, server, storage device or other processing platform element. A given such element is viewed as an example of what is more generally referred to herein as a “processing device.” The cloud infrastructure 300 shown in FIG. 3 may represent at least a portion of one processing platform. Another example of such a processing platform is processing platform 400 shown in FIG. 4.

The processing platform 400 in this embodiment comprises a portion of the information processing system 100 and includes a plurality of processing devices, denoted 402-1, 402-2, 402-3, . . . 402 -K, which communicate with one another over a network 404.

The network 404 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 402-1 in the processing platform 400 comprises a processor 410 coupled to a memory 412.

The processor 410 comprises a microprocessor, a microcontroller, an application-specific integrated circuit (ASIC), a field-programmable gate array (FPGA) or other type of processing circuitry, as well as portions or combinations of such circuitry elements.

The memory 412 comprises random access memory (RAM), read-only memory (ROM) or other types of memory, in any combination. The memory 412 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 402-1 is network interface circuitry 414, which is used to interface the processing device with the network 404 and other system components, and may comprise conventional transceivers.

The other processing devices 402 of the processing platform 400 are assumed to be configured in a manner similar to that shown for processing device 402-1 in the figure.

Again, the particular processing platform 400 shown in the figure is presented by way of example only, and the information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method comprising:
reading, by an exporter creation system, a configuration file associated with a microservice;
generating, by the exporter creation system, a metric exporter for metrics associated with the microservice, wherein the metric exporter is generated according to event monitoring system specifications using the configuration file;
registering, by the exporter creation system, the metric exporter with a library associated with an event monitoring system; and
providing, by the metric exporter, the metrics to the event monitoring system upon receiving a request from the event monitoring system, wherein the method is implemented by at least one processing device comprising a processor coupled to a memory.

2. The method of claim 1 further comprising:
initiating a server, by the exporter creation system in the microservice, wherein the server receives the request from the event monitoring system to provide the metrics to the event monitoring system.

3. The method of claim 2 wherein initiating a server comprises:
obtaining, by the exporter creation system, a value of a port associated with the server.

4. The method of claim 3 wherein obtaining by the exporter creation system the value of the port comprises:
obtaining the value of the port from at least one of the configuration file, a second configuration file and source code associated with the microservice.

5. The method of claim 1 wherein generating, by the exporter creation system, the metric exporter comprises:
generating the metric exporter during a runtime initialization of the microservice.

6. The method of claim 1 wherein generating, by the exporter creation system, the metric exporter comprises:
identifying an array in the configuration file, wherein the array comprises at least one metric element; and
generating a collector object according to the event monitoring system specifications for each metric element in the array.

7. The method of claim 6 wherein the at least one metric element comprises at least one event monitoring system construct used by the event monitoring system.

8. The method of claim 6 wherein the at least one metric element comprises a collector section identifying a location of metric generating logic in source code associated with the microservice, wherein the metric generating logic generates a portion of the metrics associated with the microservice.

9. The method of claim 8 wherein the exporter creation system parses the configuration file to locate the collector section, wherein the collector section comprises method implementations of the metric generating logic in the source code.

10. The method of claim 9 wherein the exporter creation system provides an abstract method from which the method implementations of the metric generating logic are generated as concrete implementations of the abstract method.

11. The method of claim 10 wherein the exporter creation system constructs an instance of each of the concrete implementations and creates a respective collector object from each instance.

12. The method of claim 11 wherein each respective collector object comprises a respective reference to the instance of each of the concrete implementations and a respective reference to each of the at least one event monitoring system construct used by the event monitoring system.

13. The method of claim 9 wherein the exporter creation system is written in an interpreted language, and wherein the collector section comprises at least one module name of a module that contains the method implementations of the metric generating logic in the source code.

14. The method of claim 6 wherein the collector object has a reference to at least one event monitoring system construct used by the event monitoring system.

15. The method of claim 1 wherein the configuration file is written in a data serialization language.

16. The method of claim 1 wherein registering, by the exporter creation system, the metric exporter with a library associated with an event monitoring system comprises:
registering a collector object associated with the configuration file with the library associated with the event monitoring system.

17. A system comprising:
at least one processing device comprising a processor coupled to a memory;
the at least one processing device being configured:
to read, by an exporter creation system, a configuration file associated with a microservice;
to generate, by the exporter creation system, a metric exporter for metrics associated with the microservice, wherein the metric exporter is generated according to event monitoring system specifications using the configuration file;
to register, by the exporter creation system, the metric exporter with a library associated with an event monitoring system; and
to provide, by the metric exporter, the metrics to the event monitoring system upon receiving a request from the event monitoring system.

18. The system of claim 17 further configured to:
initiate a server, by the exporter creation system in the microservice, wherein the server receives the request from the event monitoring system to provide the metrics to the event monitoring system.

19. A computer program product comprising a non-transitory processor-readable storage medium having stored therein program code of one or more software programs, wherein the program code when executed by at least one processing device causes said at least one processing device:
to read, by an exporter creation system, a configuration file associated with a microservice;
to generate, by the exporter creation system, a metric exporter for metrics associated with the microservice, wherein the metric exporter is generated according to event monitoring system specifications using the configuration file;
to register, by the exporter creation system, the metric exporter with a library associated with an event monitoring system; and
to provide, by the metric exporter, the metrics to the event monitoring system upon receiving a request from the event monitoring system.

20. The computer program product of claim 19 further configured to:
initiate a server, by the exporter creation system in the microservice, wherein the server receives the request from the event monitoring system to provide the metrics to the event monitoring system.
